(19) United States
(12) Patent Application Publication
(10) Pub. No.: US 2008/0005421 A1
(43) Pub. Date: Jan. 3, 2008

(54) Switching Device of Input and Output Interfaces of Computer Systems

(76) Inventors: Chi-Tung Chang, Taipei City (TW); Wen-Chih Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/459,027

(22) Filed: Jul. 21, 2006

Related U.S. Application Data
(60) Provisional application No. 60/767,530, filed on May 19, 2006.

(51) Int. Cl. G06F 13/38

(52) U.S. Cl. 710/62

(57) ABSTRACT

A switching device of input and output interfaces of computer systems includes a plurality of primary ports for electrically connecting transmission interfaces of the plurality of the computer systems, a plurality of secondary port for electrically connecting transmission interfaces of a plurality of input devices, a hub device coupled between the plurality of primary ports and the plurality of secondary ports, an audio decoding unit coupled to the hub device, for decoding audio signals, a control unit coupled to the hub device, for controlling the hub device, so as to couple a primary port of the plurality of primary ports to the plurality of secondary ports and the audio decoding unit, and an audio output port coupled to the audio decoding unit, for outputting decoded results of the audio decoding unit.

### CROSS REFERENCE TO RELATED APPLICATIONS

This application claims the benefit of U.S. Provisional Application No. 60/767,530, filed May 19, 2006, and included herein by reference.

### BACKGROUND OF THE INVENTION

1. Field of the Invention

The present invention provides a switching device of input and output interfaces of computer systems, and more particularly, a switching device capable of decreasing transmission wires and audio ports, and enhancing audio quality.

2. Description of the Prior Art

In the prior art, a user can use a multi-computer switch to switch controls of multiple computer systems with the same keyboard, monitor, and mouse. The multi-computer switch is so-called KVM (keyboard, video, and mouse) switch, meaning that a user can use a set of keyboard, monitor, and mouse to control all computer systems and show corresponding images. In fact, other than the keyboard, monitor, and mouse, the prior art multi-computer switch can also switch other peripherals. With the multi-computer switch, costs of keyboards, mouses, monitors, or speakers corresponding to the computer systems are reduced, and desktop space is increased. For example, an administrator can use the same keyboard, mouse, monitor, speakers to manage network servers or a server farm including a plurality of computer systems with the multi-computer switch.

In an early or analog multi-computer switch, four wires are required for coupling ports of keyboard, mouse, video, and audio of a computer system to the multi-computer switch. In order to reduce the wires, the prior art provides a multi-computer switch including a USB (universal serial bus) hub, which can replace two wires with a USB wire.

Please refer to FIG. 1, which illustrates a schematic diagram of a prior art multi-computer switch 10. The multi-computer switch 10 includes a hub device 100, an analog audio switching device 102, and an analog video switching device 104. The hub device 100 establishes signal connections with computer systems PC1 to PCn through USB upstream interfaces UP_USB1 to UP_USBn. The hub device 100 also establishes signal connections with a keyboard 106, a mouse 108, or other USB devices, such as gamepads, card readers, digital cameras, etc., through USB downstream interfaces DP_USB1 to DP_USBn. According to a control signal Vct, the multi-computer switch 10 couples one of the upstream interfaces UP_USB1 to UP_USBn to all the downstream interfaces DP_USB1 to DP_USBn, and outputs audio and video signals of a corresponding computer system to the speaker 110 and the monitor 112 through the analog audio switching device 102 and the analog video switching device 104. For example, if a user wants to control the computer system PC1, the user can control the multi-computer switch 10 to couple the upstream interface UP_USB1 to all the downstream interfaces DP_USB1 to DP_USBn, and to output audio and video signals of the computer system PC1 to the speaker 110 and the monitor 112 through the analog audio switching device 102 and the analog video switching device 104. As a result, the user can control the computer system PC1 with the keyboard 106 and the mouse 108, and play and display multimedia outputs of the computer system PC1 from the speaker 110 and the monitor 112. Therefore, the user can use the keyboard 106 and the mouse 108 to control the computer systems PC1 to PCn, and use the speaker 110 and the monitor 112 to play and display audio and video signals of the computer system PC1 to PCn.

Therefore, the multi-computer switch 10 uses one USB wire connecting a computer system for replacing required wires of connections of the keyboard and the mouse. Meanwhile, since USB can connect 127 peripherals at most and support “hot attach & detach” and “plug-and-play”, the hub device 100 can be inserted a variety of peripherals having USB terminals, such as floppy drives, optical disc drives, gamepads, modems, printers, magnetic tape stations, scanners, telephones, etc. However, as shown in FIG. 1, even if a USB wire replaces two wires of connections of the keyboard and the mouse, each of the computer systems PC1 to PCn still needs an audio wire and a video wire for transmitting audio and video signals to the analog audio switching device 102 and the analog video switching device 104. That is, each of the computer systems PC1 to PCn requires three wires to couple ports or slots of keyboard, mouse, monitor, and speaker to the multi-computer switch 10. If there are plenty of computer systems to be controlled by the multi-computer switch 10, required wires will increase costs and desktop disorder. In addition, the analog audio switching device 102 must include audio ports for receiving analog audio signals from the computer systems PC1 to PCn. The audio ports take up a lot of space, so that volume of the multi-computer switch 10 cannot be decreased. Moreover, as a length of a wire for transmitting analog audio signals increases, transmission efficiency of analog audio signals decreases, and the wire is interfered with noise, which reduces quality of the speaker 110.

In short, the cost of the wires in the prior art multi-computer switch cannot be reduced effectively, and multimedia quality is affected by lengths of the wires.

### SUMMARY OF THE INVENTION

It is therefore a primary objective of the claimed invention to provide a switching device of input and output interfaces of computer systems.

According to the claimed invention, a switching device of input and output interfaces of computer systems comprises a plurality of primary ports for electrically connecting transmission interfaces of the plurality of the computer systems, a plurality of secondary port for electrically connecting transmission interfaces of a plurality of input devices, a hub device coupled between the plurality of primary ports and the plurality of secondary ports, an audio decoding unit coupled to the hub device, for decoding audio signals, a control unit coupled to the hub device, for controlling the hub device, so as to couple a primary port of the plurality of primary ports to the plurality of secondary ports and the audio decoding unit, and an audio output port coupled to the audio decoding unit, for outputting decoded results of the audio decoding unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art multi-computer switch.

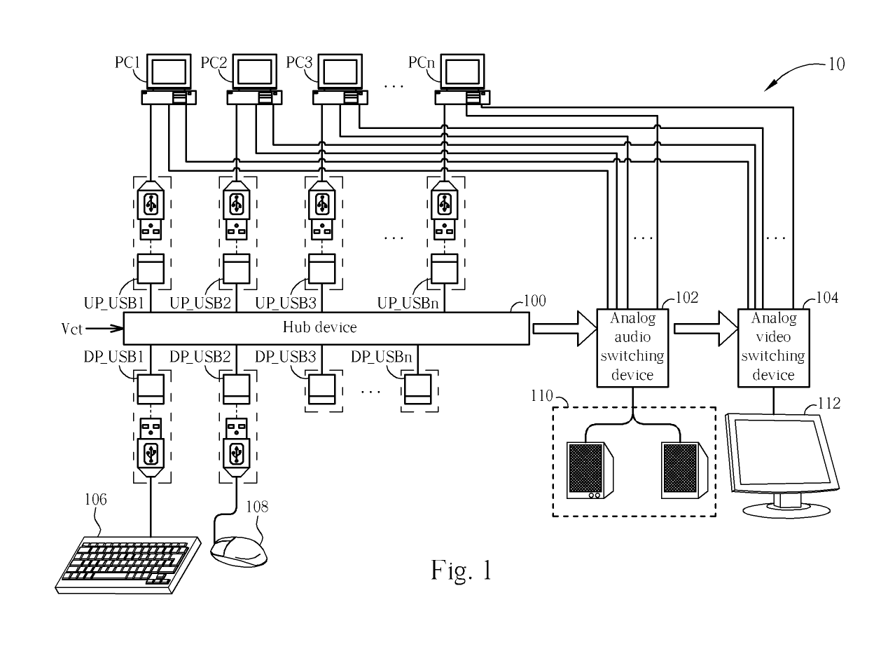

FIG. 2 illustrates a schematic diagram of a switching device in accordance with an embodiment of the present invention.

FIG. 3 illustrates a schematic diagram of an operating process of the switching device shown in FIG. 2.

### DETAILED DESCRIPTION

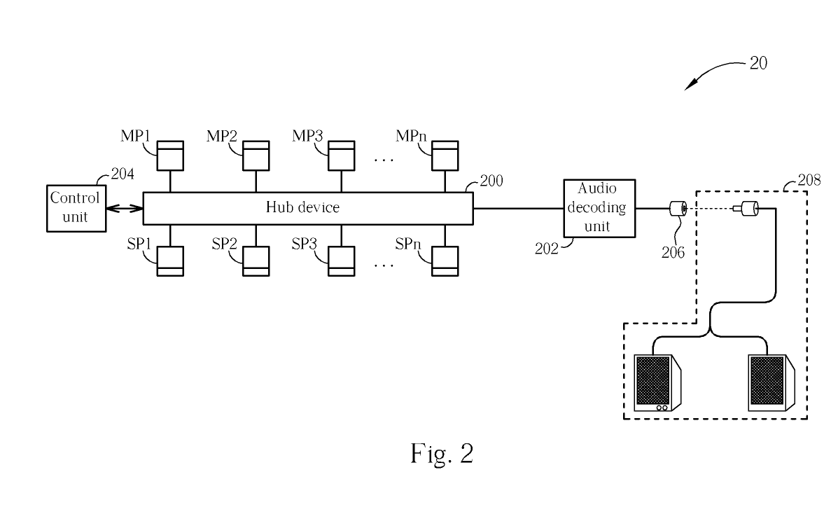

Please refer to FIG. 2, which illustrates a schematic diagram of a switching device 20 in accordance with an embodiment of the present invention. The switching device 20 is utilized for input and output interfaces of a plurality of computer systems, and includes primary ports MP1 to MPn, secondary ports SP1 to SPn, a hub device 200, an audio decoding unit 202, a control unit 204, and an audio output port 206. The primary ports MP1 to MPn are utilized for electrically connecting transmission interfaces of the computer systems. The secondary ports SP1 to SPn are utilized for electrically connecting transmission interfaces of a plurality of input devices. The hub device 200 is coupled to the primary ports MP1 to MPn and the secondary ports SP1 to SPn, and utilized for coupling one of the primary ports MP1 to MPn to all the secondary ports SP1 to SPn and the audio decoding unit 202 according to signals outputted from the control unit 204. The audio decoding unit 202 can decode audio signals outputted from the hub device 200 for the audio output port 206, so as to play audio signals with the speaker 208.

In other words, the control unit 204 controls the hub device 200 to couple one of the primary ports MP1 to MPn to all the secondary ports SP1 to SPn and the audio decoding unit 202. Therefore, the input devices coupled to the secondary ports SP1 to SPn can transmit signals to a computer system coupled to the primary port, and the audio decoding unit 202 can output audio signals of the computer system through the audio output port 206 and the speaker 208.

Preferably, the primary ports MP1 to MPn and the secondary ports SP1 to SPn conform to USB standard, and the hub device 200 is a USB hub. Since USB can connect 127 peripherals at most and support “hot attach & detach” and “plug-and-play”, the secondary ports SP1 to SPn can be inserted a variety of peripherals having USB terminals, such as floppy drives, optical disc drives, gamepads, modems, printers, magnetic tape stations, scanners, telephones, etc. Moreover, the switching device 20 can include a port transformation unit externally or internally coupled to one of the secondary ports SP1 to SPn, utilized for transforming the secondary port to a port conforming to a specified standard. For example, the port transformation unit can be a unit for transforming a USB port into a PS/2 port, or into a gamepad port (15-pin D-sub). Therefore, input devices having terminals other than USB terminals are suitable for the switching device 20. Furthermore, the switching device 20 can include an audio encoding unit and an audio input port for receiving and transmitting audio signals to a corresponding computer system.

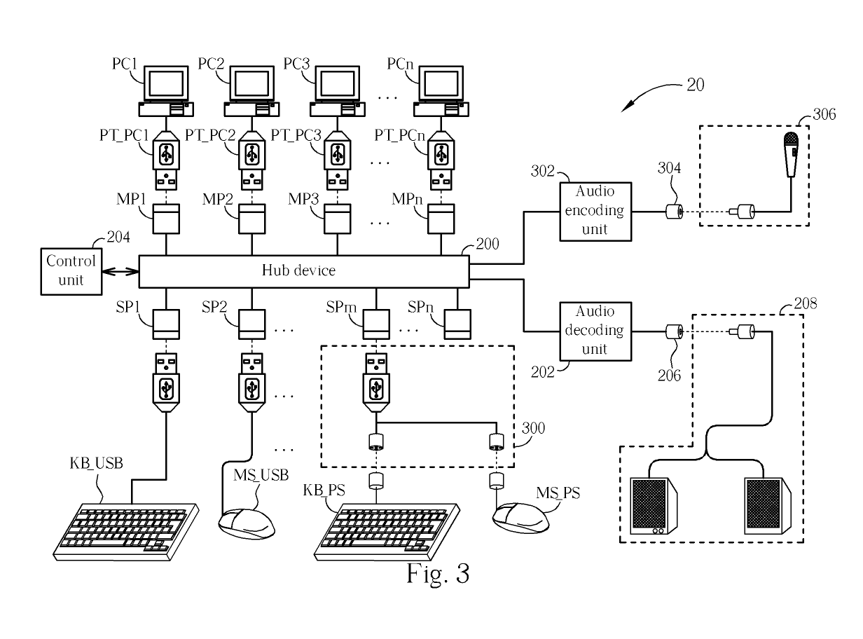

As to operations of the switching device 20, please refer to FIG. 3. In FIG. 3, interfaces PT_PC1 to PT_PCn of the computer systems PC1 to PCn are coupled to the primary ports MP1 to MPn. The interfaces PT_PC1 to PT_PCn conform to USB standard. The secondary ports SP1 to SPn can be inserted USB input devices, such as a USB keyboard KB_USB, a USB mouse MS_USB, or PS/2 input devices, such as a PS/2 keyboard KB_PS, and a PS/2 mouse MS_PS, through a port transformation unit 300. Certainly, the port transformation unit 300 can be externally connected with a secondary port SPm or integrated with the secondary port SPm inside the hub device 200. In addition, an audio encoding unit 302 and an audio input port 304 can transmit audio signals received by a microphone 306 to the hub device 200. The audio encoding unit 302 and the audio decoding unit 202 are preferably integrated into a chip.

If a user wants to control one of the computer systems PC1 to PCn, the user can send a command to the control unit 204 through a control signal reception unit (not shown in FIG. 3), then the control unit 204 will couple a corresponding primary port to the secondary ports SP1 to SPn, the audio decoding unit 202, and the audio encoding unit 302. After that, the user can control the computer system with the keyboard KB_USB and the mouse MS_USB or the keyboard KB_PS and the mouse MS_PS, output audio signals with the speaker 208, and input audio signals with the microphone 306. Certainly, the user can insert other input or output devices into the secondary ports SP1 to SPn.

Therefore, as shown in FIG. 3, each of the computer systems PC1 to PCn uses single wire to receive signals from the input devices (keyboard, mouse, gamepad, etc.), and to output signal to output devices (speaker, printer, etc.). That is, the switching device 20 can reduce required wires, so as to decrease cost. Moreover, the switching device 20 need not include any analog audio switching device, so that audio ports are unnecessary and volume of the switching device 20 can be decreased. Most important of all, digital audio signals are composed of bits of “0” and “1”, and can be obtained real sound effects through demodulation, decoding, and other operations, so that the output quality of the speaker 208 is free from a length of a wire.

With the audio decoding unit 202, audio signals can be integrated into USB signals, so as to decrease wires and audio ports and keep audio quality. Certainly, the switching device 20 can include an analog video switching device for switching video sources.

In summary, with the audio decoding unit, the present invention can decrease required wires audio ports and enhance audio quality, so as to decrease hardware costs and enhance multimedia effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switching device of input and output interfaces of computer systems, comprising:
a plurality of primary ports for electrically connecting transmission interfaces of the plurality of the computer systems;
a plurality of secondary port for electrically connecting transmission interfaces of a plurality of input devices;
a hub device coupled between the plurality of primary ports and the plurality of secondary ports;
an audio decoding unit coupled to the hub device, for decoding audio signals;
a control unit coupled to the hub device, for controlling the hub device, so as to couple a primary port of the plurality of primary ports to the plurality of secondary ports and the audio decoding unit; and
an audio output port coupled to the audio decoding unit, for outputting decoded results of the audio decoding unit.

2. The switching device of claim 1, wherein a primary port of the plurality of primary ports is a universal serial bus port.

3. The switching device of claim 1, wherein a secondary port of the plurality of secondary ports is a universal serial bus port.

4. The switching device of claim 1, further comprising a port transformation unit coupled a secondary port of the plurality of secondary ports, for transforming the secondary port to a port conforming to a specified standard.

5. The switching device of claim 4, wherein the port is utilized for electrically connecting a PS/2 terminal of an electronic device.

6. The switching device of claim 4, wherein the port is utilized for electrically connecting a terminal of a gamepad.

7. The switching device of claim 1, wherein the plurality of input devices comprises a keyboard and a mouse.

8. The switching device of claim 1, further comprising:
an audio input port for receiving audio signals; and
an audio encoding unit coupled to the audio input port and the hub device, for encoding signals received by the audio input port into packets, and transmitting the packets to the hub device.

9. The switching device of claim 8, wherein the control unit is utilized for coupling the primary port to the audio encoding unit.

10. The switching device of claim 8, wherein the audio encoding unit is integrated in the audio decoding unit.

11. The switching device of claim 1, further comprising a control signal reception unit coupled to the control unit, for receiving control signals from a user, and transmitting the control signals to the control unit.
